(19) United States
(12) Patent Application Publication
(10) Pub. No.: US 2026/0094757 A1
(43) Pub. Date: Apr. 2, 2026

(54) COIL COMPONENT

(71) Applicant: Murata Manufacturing Co., Ltd., Kyoto-fu (JP)

(72) Inventors: Yuki KANBE, Nagaokakyo-shi (JP); Keita ASAI, Nagaokakyo-shi (JP); Shingo NAKAMOTO, Nagaokakyo-shi (JP); Yuto MANAKA, Nagaokakyo-shi (JP)

(73) Assignee: Murata Manufacturing Co., Ltd., Kyoto-fu (JP)

(21) Appl. No.: 19/335,733

(22) Filed: Sep. 22, 2025

(30) Foreign Application Priority Data
Sep. 28, 2024 (JP) 2024-169697

(51) Int. Cl. H01F 27/30; H01F 27/28; H01F 27/29; H01F 27/32

(52) U.S. Cl. CPC H01F 27/306; H01F 27/2828; H01F 27/29; H01F 27/324

(57) ABSTRACT

A plated metal film is formed on a wire placement surface of a terminal electrode. The plated metal film includes a nickel layer serving as a base and a tin layer as a surface layer. The wire extends along the wire placement surface and is bonded to the wire placement surface, in a connection portion between the wire and the wire placement surface, by a bonding member that contains a metal, such as tin, derived from the plated metal film. A fillet that contains a metal, such as tin, derived from the plated metal film is formed so as to fill in the gap between the wire and the wire placement surface at the end of the wire placement surface from which the wire extends toward a winding core portion.

### CROSS-REFERENCE TO RELATED APPLICATION

This application claims benefit of priority to Japanese Patent Application No. 2024-169697, filed Sep. 28, 2024, the entire content of which is incorporated herein by reference.

### BACKGROUND

### Technical Field

The present disclosure relates to a coil component and terminal electrodes. The coil component includes a winding core portion around which a wire is wound and flanges disposed at opposite ends of the winding core portion in the axial direction thereof. The terminal electrodes are disposed at respective flanges and the wire is connected to the terminal electrodes. More specifically, the present disclosure relates to a structure of a connection portion between the wire and each terminal electrode.

### Background Art

For example, Japanese Unexamined Patent Application Publication No. 2013-191694 describes a coil component equipped with a core that includes a winding core portion around which a wire is wound and flanges disposed at opposite ends of the winding core portion. FIG. 3 is adopted from Japanese Unexamined Patent Application Publication No. 2013-191694 and corresponds to FIG. 7(b) of Japanese Unexamined Patent Application Publication No. 2013-191694.

As illustrated in FIG. 3, a coil component 61 is equipped with a core 64 that includes a winding core portion 62 and a flange 63 disposed at each end of the winding core portion 62 in the axial direction of the winding core portion 62. FIG. 3 illustrates part of the coil component 61. Note that FIG. 3 does not illustrate a counterpart flange positioned symmetrically to the illustrated flange 63 in the coil component 61. A wire 65 is wound around the winding core portion 62, and an end portion of the wire 65 is connected to a terminal electrode 66 of the flange 63 using thermocompression bonding. More specifically, the wire 65 contains copper, whereas the terminal electrode 66 contains tin at least in a surface portion thereof. Accordingly, the thermocompression bonding produces an alloy of the copper and the tin, and the alloy layer bonds the wire 65 to the terminal electrode 66.

According to the structure described in Japanese Unexamined Patent Application Publication No. 2013-191694, a step is formed at a bottom surface 67 of the flange 63, and a bottom portion 68 of the terminal electrode 66 is shaped so as to follow the shape of the step. As a result, when the wire 65 is fixed to the bottom portion 68 of the terminal electrode 66 using the thermocompression bonding, the wire 65 can be prevented from receiving compression forces at a lower part of the bottom portion 68 of the terminal electrode 66. This can restrict the area in which the alloy layer is formed and thereby prevent the end portion of the wire 65 from being bonded thermally. According to Japanese Unexamined Patent Application Publication No. 2013-191694, this makes it easier to cut off an excessive end portion of the wire 65.

### SUMMARY

In the structure described in Japanese Unexamined Patent Application Publication No. 2013-191694, however, a portion of the wire 65 that is in contact with the bottom portion 68 of the terminal electrode 66 may be flattened, although not illustrated in FIG. 3, due to the pressure applied by the heater tip used in the thermocompression bonding. This may decrease the strength of the wire 65.

In this case, the portion of the wire 65 being in contact with the bottom portion 68 of the terminal electrode 66 has a flattened cross section. On the other hand, a portion of the wire 65 that extends from the bottom portion 68 of the terminal electrode 66 toward the winding core portion 62 maintains an original circular cross section. In other words, the cross-sectional shape of the wire 65 changes between the portion being in contact with the bottom portion 68 of the terminal electrode 66 and the portion extending from the bottom portion 68 of the terminal electrode 66 toward the winding core portion 62. The change of the cross-sectional shape tends to be abrupt near an edge 69 of the bottom portion 68 of the terminal electrode 66, the edge 69 facing the winding core portion 62.

If the wire 65 is stretched due to an external cause, the stress tends to concentrate in a portion of the wire 65 where the cross-sectional shape changes abruptly, which tends to cause wire breakage.

One solution to this problem may be to narrow the pressing area of the heater tip and thereby alleviate the abrupt change of the cross-sectional shape of the wire 65. However, this may result in the insufficient bonded area by the thermocompression bonding, which may aggravate the reliability of connection between the wire 65 and the terminal electrode 66.

Accordingly, the present disclosure provides a coil component that can reduce the occurrence of wire breakage and improve the reliability of connection between the wire and the terminal electrode.

The present disclosure is directed to a coil component that includes a core including a winding core portion and flanges formed at respective ends of the winding core portion in an axial direction of the winding core portion; a wire wound around the winding core portion; and terminal electrodes that are disposed at the respective flanges and made of metal plates and to which the wire extended from the winding core portion is connected.

Each flange has a bottom surface facing a circuit board and a top surface facing oppositely, and each terminal electrode is disposed at the bottom surface of a corresponding flange.

The terminal electrode has a wire placement surface on which the wire is disposed, and a plated metal film is formed on the wire placement surface.

The wire extends along the wire placement surface and is bonded to the terminal electrode, in connection portions between the wire and the wire placement surface, by a bonding member that contains a metal derived from the plated metal film.

A characteristic feature of the present disclosure is that a fillet containing the metal derived from the plated metal film is formed, at an end of the wire placement surface from which the wire extends toward the winding core portion, so as to fill in a gap between the wire and the wire placement surface at at least one of the connection portions.

In the present disclosure, the bonding member containing the metal derived from the plated metal film bonds the wire extending along the wire placement surface to the wire placement surface. More specifically, the fillet is formed so as to fill in the gap between the wire and the wire placement surface at the end of the wire placement surface and thereby bonds the wire to the terminal electrode. Bonding the wire using the fillet in such a manner improves the reliability of the connection between the wire and the terminal electrode.

In addition, the fillet is located at a position where the wire is not substantially subjected to the stress caused by thermocompression bonding. In other words, a heater tip used in the thermocompression bonding can be prevented from reaching the end of the wire placement surface. Accordingly, even if the wire is stretched due to an external cause, the fillet can maintain the strength of the wire and prevent the wire from breaking.

In addition, the wire tends to be broken easily at the end of the wire placement surface of the terminal electrode where the cross-sectional shape of the wire tends to change between a portion being in contact with the wire placement surface and a portion extending from the end of the wire placement surface toward the winding core portion. According to the present disclosure, however, the fillet is formed at the end of the wire placement surface and thereby reinforces the wire and prevents the wire from breaking.

### BRIEF DESCRIPTION OF THE DRAWINGS

FIG. 1 is a perspective view illustrating the external appearance of a coil component according to an embodiment of the present disclosure with bottom surfaces of the coil component 1 facing upward;

FIG. 2 is an enlarged cross-sectional view schematically illustrating a connection portion between a first end portion of a first wire of FIG. 1 and a wire connection portion of a first terminal electrode of FIG. 1, the connection portion being cut in the longitudinal direction of the wire; and

FIG. 3 is a view for explaining FIG. 7(b) of Japanese Unexamined Patent Application Publication No. 2013-191694.

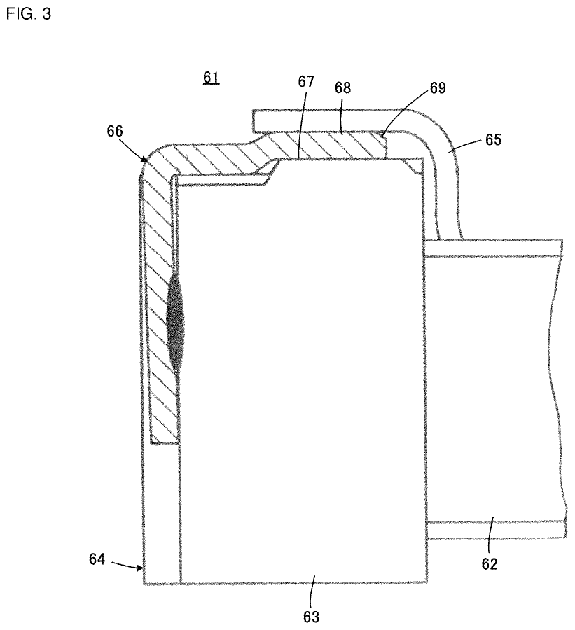

### DETAILED DESCRIPTION

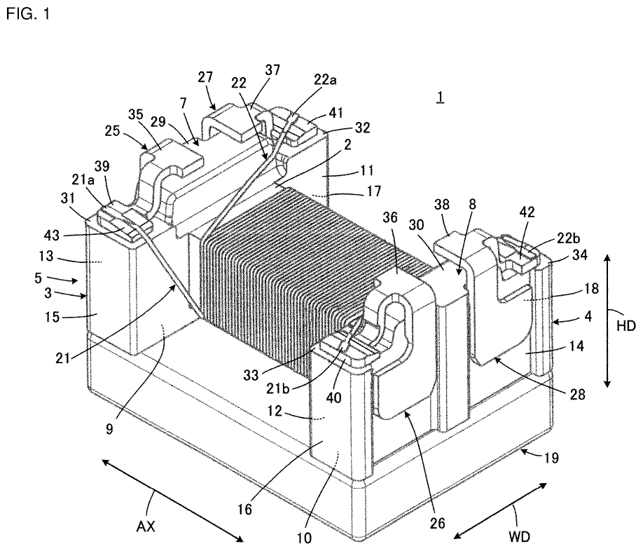

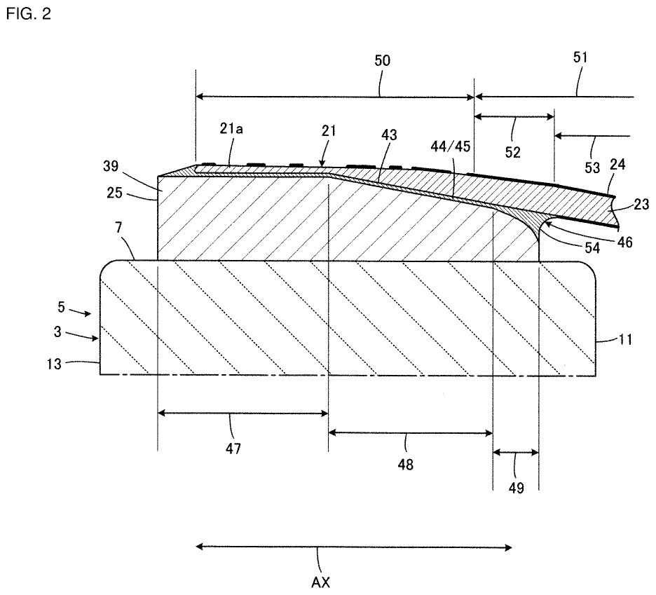

A coil component 1 according to an embodiment of the present disclosure will be described with reference to FIGS. 1 and 2.

As illustrated in FIG. 1, the coil component 1 is equipped with a drum-like core 5 that includes a winding core portion 2, a first flange 3, and a second flange 4. The first flange 3 and the second flange 4 are disposed at respective ends of the winding core portion 2, the ends facing oppositely in an axial direction AX. For example, the core 5 is made of ferrite, a non-conductive material other than ferrite, or a resin containing ferrite powder or magnetic metal powder. In FIG. 1, the winding core portion 2 has a shape of which the transverse cross-section is substantially rectangular. The cross-section, however, may be shaped like a polygon such as a hexagon, a circle, an oval, or a combination of these.

The first flange 3 has a bottom surface 7, a top surface 9, an end inner surface 11, an end outer surface 13, a first side surface 15, and a second side surface 17. When the coil component 1 is mounted onto a circuit board, the bottom surface 7 faces the circuit board, and the top surface 9 faces oppositely. The end inner surface 11 is connected between the bottom surface 7 and the top surface 9. The end inner surface 11 faces the winding core portion 2 and is positioned at an end of the winding core portion 2 in the axial direction AX thereof. The end outer surface 13 faces opposite to the end inner surface 11. The first side surface 15 and the second side surface 17 are connected between the end inner surface 11 and the end outer surface 13 so as to face opposite to each other.

Similarly, the second flange 4 has a bottom surface 8, a top surface 10, an end inner surface 12, an end outer surface 14, a first side surface 16, and a second side surface 18. When the coil component 1 is mounted onto a circuit board, the bottom surface 8 faces the circuit board, and the top surface 10 faces opposite. The end inner surface 12 is connected between the bottom surface 8 and the top surface 10. The end inner surface 12 faces the winding core portion 2 and is positioned at the other end of the winding core portion 2 in the axial direction AX. The end outer surface 14 faces opposite to the end inner surface 12. The first side surface 16 and the second side surface 18 are connected between the end inner surface 12 and the end outer surface 14 so as to face opposite to each other.

For example, the core 5 has a dimension of 3.5 mm in the axial direction AX and a dimension of 2.6 mm in a width direction WD that is the direction in which the first side surfaces 15 and 16 face opposite to the second side surfaces 17 and 18. The core 5 also has a dimension of 1.4 mm in a height direction HD that is the direction in which the bottom surfaces 7 and 8 face opposite to the top surfaces 9 and 10.

The coil component 1 may be provided with a top plate 19 that is connected between the top surface 9 of the first flange 3 and the top surface 10 of the second flange 4 of the core 5. The top plate 19 is adhered to the core 5 using an adhesive. For example, the top plate 19 is made of ferrite, a non-conductive material other than ferrite, or a resin containing ferrite powder or magnetic metal powder. The core 5 may be coated with a resin instead of being provided with the top plate 19. The core 5 does not need to have the top plate 19 nor the resin coating.

For example, the coil component 1 serves as a common mode choke coil and includes a first wire 21 and a second wire 22 that are wound around the winding core portion 2 of the core 5. In the common mode choke coil, as is well known, the first wire 21 and the second wire 22 are wound in the same direction around the winding core portion 2. As is the case for the wire 21 illustrated in FIG. 2, each of the wires 21 and 22 includes a center conductor 23 and an insulating film 24. The center conductor 23 is made of a highly conductive metal containing, for example, copper or tough pitch copper. The insulating film 24 covers the center conductor 23 and is made of an insulating resin, such as polyamide-imide, polyurethane, or polyesterimide. In FIG. 2, the thick lines represent the insulating film 24. The diameter of the wires 21 and 22 is not specifically limited but may be 15 μm or more and 140 μm or less (i.e., from 15 μm to 140 μm). The wires 21 and 22 each preferably have the cross-section shaped circular or substantially circular.

A first terminal electrode 25 and a third terminal electrode 27 are disposed at the bottom surface 7 of the first flange 3 so as to be arranged in the width direction WD with spacing provided therebetween. A second terminal electrode 26 and a fourth terminal electrode 28 are disposed at the bottom surface 8 of the second flange 4 so as to be arranged in the width direction WD with spacing provided therebetween. The terminal electrodes 25 to 28 are fixed to the flanges 3 and 4 using an adhesive.

The first wire 21 includes a first end portion 21a and a second end portion 21b at opposite ends thereof. The first end portion 21a and the second end portion 21b are connected to the first terminal electrode 23 and the second terminal electrode 24, respectively, using thermocompression bonding. The second wire 22 includes a first end portion 22a and a second end portion 22b at opposite ends thereof. The first end portion 22a and the second end portion 22b are connected to the third terminal electrode 25 and the fourth terminal electrode 26, respectively, using thermocompression bonding. The connection portions at which the wires 21 and 22 are connected to the corresponding terminal electrodes 23 to 26 will be described later in detail.

A projection 29 is formed at the bottom surface 7 of the first flange 3, and a projection 30 is formed at the bottom surface 8 of the second flange 4. The projections 29 and 30 are projected from central portions of respective bottom surfaces 7 and 8, the central portions being positioned in the width direction WD. Shoulders 31 and 32 are formed at both sides of the projection 29 in the width direction. The height of the shoulders 31 and 32 is smaller than that of the projection 29. Shoulders 33 and 34 are formed at both sides of the projection 30 in the width direction. The height of the shoulders 33 and 34 is smaller than that of the projection 30.

The first terminal electrode 25 has a curved portion that is shaped like the letter S and that extends along the projection 29 and the shoulder 31 at the bottom surface 7 of the first flange 3. The second terminal electrode 26 has a curved portion that is shaped like the letter S and that extends along the projection 30 and the shoulder 33 at the bottom surface 8 of the second flange 4. The third terminal electrode 27 has a curved portion that is shaped like the letter S and that extends along the projection 30 and the shoulder 32 at the bottom surface 7 of the first flange 3. The fourth terminal electrode 28 has a curved portion that is shaped like the letter S and that extends along the projection 30 and the shoulder 34 at the bottom surface 8 of the second flange 4.

A portion of the first terminal electrode 25 that extends along the projection 29 serves as a mounting portion 35 that is a connection portion between the first terminal electrode 25 and the circuit board (not illustrated). A portion of the first terminal electrode 25 that extends along the shoulder 31 serves as a wire connection portion 39 that is a connection portion between the first terminal electrode 25 and the first end portion 21a of the first wire 21.

A portion of the second terminal electrode 26 that extends along the projection 30 serves as a mounting portion 36 that is a connection portion between the second terminal electrode 26 and the circuit board. A portion of the second terminal electrode 26 that extends along the shoulder 33 serves as a wire connection portion 40 that is a connection portion between the second terminal electrode 26 and the second end portion 21b of the first wire 21.

A portion of the third terminal electrode 27 that extends along the projection 29 serves as a mounting portion 37 that is a connection portion between the third terminal electrode 27 and the circuit board. A portion of the third terminal electrode 27 that extends along the shoulder 32 serves as a wire connection portion 41 that is a connection portion between the third terminal electrode 27 and the first end portion 22a of the second wire 22.

A portion of the fourth terminal electrode 28 that extends along the projection 30 serves as a mounting portion 38 that is a connection portion between the fourth terminal electrode 28 and the circuit board. A portion of the fourth terminal electrode 28 that extends along the shoulder 34 serves as a wire connection portion 42 that is a connection portion between the fourth terminal electrode 28 and the second end portion 22b of the second wire 22.

The following describes a preferable structure of the connection portions between the wires 21 and 22 and the corresponding terminal electrodes 25 to 28. FIG. 2 is an enlarged cross-sectional view illustrating the connection portion between the first end portion 21a of the first wire 21 of FIG. 1 and the wire connection portion 39 of the first terminal electrode 25, the cross-section being taken by cutting the connection portion in the longitudinal direction of the wire 21. This connection portion is a representative one of the connection portions between the wires 21 and 22 and the corresponding terminal electrodes 25 to 28.

For example, the terminal electrode 25 is a metal plate made of a metal containing copper, such as phosphor bronze, as a main ingredient. A plated metal film 44 is formed on a surface of the metal plate that faces the outside.

FIG. 2 illustrates the wire connection portion 39 of the first terminal electrode 25 and the first end portion 21a of the first wire 21. The wire connection portion 39 and the first end portion 21a are disposed at the bottom surface 7 of the first flange 3. A gap may be provided between the wire connection portion 39 and the bottom surface 7. The wire connection portion 39 has a wire placement surface 43 on which the wire 21 is to be disposed. The plated metal film 44 is formed on the wire placement surface 43. Note that FIG. 2 illustrates a state after the wire 21 is bonded to the wire placement surface 43 using thermocompression bonding, and accordingly the plated metal film 44 does not remain intact. In other words, FIG. 2 illustrates a bonding member 45 that contains metals derived from the plated metal film 44. Note that the plated metal film 44 and the bonding member 45 cannot be distinguished clearly from each other in the illustration of FIG. 2.

The plated metal film 44 preferably includes a nickel layer serving as a base and a tin layer as a surface layer. When the wire 21 is bonded to the wire placement surface 43 using the thermocompression bonding, an alloy is formed of the metals contained in the plated metal film 44 and the metal contained in the wire 21, and the solidified alloy serves as the bonding member 44. As described above, the wire 21 contains copper. Accordingly, the alloy serving as the bonding member 45 contains an Sn—Cu alloy or an Sn—Cu—Ni alloy. The bonding member 45 bonds the wire 21 to the wire placement surface 43 together strongly.

A distinctive feature of the present disclosure is that in the connection portion between the wire 21 and the terminal electrode 25, a fillet 46 that contains the metal derived from the plated metal film 44 is formed so as to fill in the gap between the wire 21 and the wire placement surface 43 at an end of the wire placement surface 43 from which the wire 21 extends toward the winding core portion 2 (see FIG. 1).

The following further describes other characteristics of the embodiment illustrated in FIG. 2.

The wire placement surface 43 includes a reference surface 47, a first slope 48, and a second slope 49 in the order from the tip end of wire 21 toward the winding core portion 2. The reference surface 47 extends parallel to, or substantially parallel to, the axial direction AX of the winding core portion 2. The first slope 48 inclines such that the first slope 48 comes closer to the top surface 9 of the flange 3 (see FIG. 1) as the first slope 48 comes further away from the reference surface 47. The second slope 49 further inclines relative to the first slope 48 in such a manner that the second slope 49 comes closer to the top surface 9 of the flange 3 as the second slope 49 comes further away from the first slope 48. The fillet 46 is formed so as to fill in the gap between the wire 21 and at least the second slope 49. The slopes 48 and 49, especially the slope 49 (second slope 49), can facilitate the formation of the fillet 46. The first slope 48 enables the wire 21 to obtain a sufficient thickness at a compressed portion 50 of the wire 21. The first slope 48 and the second slope 49 may be flat surfaces or may be curved surfaces.

The wire 21 includes a portion that extends along the wire placement surface 43, and the portion is further divided into a compressed portion 50 and a noncompressed portion 51. The compressed portion 50 is positioned closer to the tip end of the wire 21 and has a squashed and flat shape due to the thermocompression bonding. The noncompressed portion 51, which is the portion other than the compressed portion 50, is positioned closer to the winding core portion 2. The noncompressed portion 51 further includes a first noncompressed portion 52, which is positioned closer to the end of the wire 21, and a second noncompressed portion 53, which is positioned closer to the winding core portion 2.

In the compressed portion 50, the insulating film 24 of the wire 21 is present intermittently but is not present at least on a portion of the wire 21 that faces the wire placement surface 43. In the first noncompressed portion 52, the insulating film 24 is present continuously in the longitudinal direction of the wire 21 except where the fillet 46 is formed. In the second noncompressed portion 53, the insulating film 24 is present continuously in the longitudinal direction of the wire 21 and also around the entire circumference of the wire 21.

In the longitudinal direction of the wire 21, a projected region of the first noncompressed portion 52 encompasses a projected region of the second slope 49. According to this configuration, a portion of the wire 21 where the fillet 46 is formed on the second slope 49 can be prevented from receiving damage due to the thermocompression bonding, which can maintain sufficient strength of wire 21 against tensile stress.

In the longitudinal direction of the wire 21, the projected region of the second slope 49 is positioned closer to the compressed portion 50 than is a projected boundary between the first noncompressed portion 52 and the second noncompressed portion 53. According to this configuration, the end of the fillet 46 that is in contact with the wire 21 can be positioned closer to the winding core portion 2 than is the end of the wire placement surface 43. In other words, the bonding interface between the wire 21 and the fillet 46 extends over the end of the wire placement surface 43 toward winding core portion 2. Accordingly, the bonded area between the wire 21 and the wire placement surface 43 can be expanded over the end of the wire placement surface 43 toward the winding core portion 2, which can increase the bonding strength therebetween.

When a cross section of the fillet 46 is viewed, the cross section being taken by cutting the fillet 46 by a plane that extends in the extending direction of the wire 21 and in a direction orthogonal to the wire placement surface 43, a surface 54 of the fillet 46 that faces outward is curved inward. Accordingly, the contact area between the fillet 46 and the wire 21 can be expanded, which can improve the ability of the fillet 46 for reinforcing the wire 21.

A preferred structure of the connection portion between the wire and the terminal electrode has been described by focusing on the first end portion 21a of the first wire 21 and the wire connection portion 39 of the first terminal electrode 25. This structure may be included only in the connection portion for the first end portion 21a of the first wire 21. Alternatively, this structure may be included in the connection portion for the first end portion 21a of the first wire 21 and also in at least one of the connection portions for the second end portion 21b of the first wire 21, the first end portion 22a of the second wire 22, and the second end portion 22b of the second wire 22.

In the coil component 1, as illustrated in FIG. 1, the first end portion 21a of the first wire 21 and the second end portion 22b of the second wire 22 extend in the axial direction AX, whereas the second end portion 21b of the first wire 21 and the first end portion 22a of the second wire 22 extend in the width direction WD, although this is not an indispensable feature of the present disclosure. In the wire connection portion 39, the reference surface 47, the first slope 48, and the second slope 49 are arranged in the axial direction AX on the wire placement surface 43, and the same applies to the wire connection portion 42. On the other hand, the reference surface 47, the first slope 48, and the second slope 49 are arranged in the width direction WD in the wire connection portions 40 and 41.

The present disclosure has been described with reference to the illustrated embodiment. The present disclosure can be implemented in various different embodiments within the scope of the present disclosure.

For example, the coil component of the present disclosure has been described as the common mode choke coil as in the embodiment illustrated. The coil component, however, may be a component having a single coil or may be a transformer or a balun (i.e., balanced-to-unbalanced transformer). The number of wires may be changed in accordance with the intended function of the coil component, and the number of terminal electrodes disposed in each flange may be changed accordingly.

Note that configurations in different embodiments disclosed herein can be partially replaced or combined with one another in implementing the coil component of the present disclosure.

The present disclosure can be characterized by the following features.
<1> A coil component includes a core including a winding core portion and flanges formed at respective ends of the winding core portion in an axial direction of the winding core portion; a wire wound around the winding core portion; and terminal electrodes that are made of metal plates and disposed at the respective flanges and to which the wire extended from the winding core portion is connected. Each flange has a bottom surface facing a circuit board and a top surface facing oppositely, and each terminal electrode is disposed at the bottom surface of a corresponding flange and has a wire placement surface on which the wire is disposed. A plated metal film is formed on the wire placement surface. The wire extends along the wire placement surface and is bonded to the wire placement surface, in connection portions between the wire and the wire placement surface, by a bonding member that contains a metal derived from the plated metal film. Also, a fillet containing the metal derived from the plated metal film is formed, at an end of the wire placement surface from which the wire extends toward the winding core portion, so as to fill in a gap between the wire and the wire placement surface at at least one of the connection portions.
<2> In the coil component described in <1> above, the wire includes a portion that extends along the wire placement surface, the portion including a compressed portion and a noncompressed portion. The compressed portion is positioned closer to a tip end of the wire and has a squashed and flat shape formed due to thermocompression bonding. The noncompressed portion is positioned closer to the winding core portion and has a cross-section shaped circularly or substantially circularly. The noncompressed portion includes a first noncompressed portion positioned closer to the tip end of the wire and a second noncompressed portion positioned closer to the winding core portion. A portion of the wire that is wound around the winding core portion has a cross-section shaped circularly or substantially circularly. The wire includes an insulating film. Also, in the compressed portion, the insulating film is present intermittently and is not present at least on a surface portion of the wire that faces the wire placement surface. In addition, in the first noncompressed portion, the insulating film is present continuously in a longitudinal direction of the wire except where the fillet is formed, and in the second noncompressed portion, the insulating film is present continuously in the longitudinal direction of the wire and also around an entire circumference of the wire.
<3> In the coil component described in <1> or <2> above, the fillet contains an alloy made of a metal contained in the plated metal film and a metal contained in the wire.
<4> In the coil component described in <3> above, the wire contains copper, and the plated metal film includes a nickel layer serving as a base and a tin layer as a surface layer, and the alloy contains Sn—Cu alloy or Sn—Cu—Ni alloy.
<5> In the coil component described in any one of <1> to <4> above, the wire placement surface includes a reference surface, a first slope, and a second slope in an order from a tip end of the wire toward the winding core portion. The reference surface extends parallel to, or substantially parallel to, the axial direction of the winding core portion. The first slope inclines such that the first slope comes closer to the top surface of the corresponding flange as the first slope comes further away from the reference surface. The second slope further inclines relative to the first slope in such a manner that the second slope comes closer to the top surface of the flange as the second slope comes further away from the first slope, and the fillet is formed so as to fill in the gap between the wire and at least the second slope.
<6> In the coil component described in <5> above, the wire includes a portion that extends along the wire placement surface, the portion including a compressed portion and a noncompressed portion. The compressed portion is positioned closer to a tip end of the wire and has a squashed and flat shape formed due to thermocompression bonding. The noncompressed portion is positioned closer to the winding core portion and has a cross-section shaped circularly or substantially circularly. The noncompressed portion includes a first noncompressed portion positioned closer to the tip end of the wire and a second noncompressed portion positioned closer to the winding core portion. A portion of the wire that is wound around the winding core portion has a cross-section shaped circularly or substantially circularly. The wire includes an insulating film. Also, in the compressed portion, the insulating film is present intermittently and is not present at least on a surface portion of the wire that faces the wire placement surface, in the first noncompressed portion, the insulating film is present continuously in a longitudinal direction of the wire except where the fillet is formed, and in the second noncompressed portion, the insulating film is present continuously in the longitudinal direction of the wire and also around an entire circumference of the wire.
<7> In the coil component described in <6> above, in the longitudinal direction of the wire on the wire placement surface, a projected region of the second slope is positioned closer to the compressed portion than is a projected boundary between the first noncompressed portion and the second noncompressed portion.
<8> In the coil component described in <6> above, in the longitudinal direction of the wire on the wire placement surface, a projected region of the first noncompressed portion encompasses a projected region of the second slope.
<9> In the coil component described in <8> above, in the longitudinal direction of the wire on the wire placement surface, the projected region of the second slope is positioned closer to the compressed portion than is a projected boundary between the first noncompressed portion and the second noncompressed portion.
<10> In the coil component described in any one of <1> to <9> above, when a cross section of the fillet is viewed, the cross section being taken by cutting the fillet by a plane that extends in the longitudinal direction of the wire and in a direction orthogonal to the wire placement surface, a surface of the fillet that faces outward is curved inward.

What is claimed is:

1. A coil component comprising:
a core including a winding core portion and flanges at respective ends of the winding core portion in an axial direction of the winding core portion;
a wire wound around the winding core portion; and
terminal electrodes that include metal plates and are at the respective flanges and to which the wire extended from the winding core portion is connected,
wherein
each flange has a bottom surface facing a circuit board and a top surface opposite to the bottom surface,
each terminal electrode is at the bottom surface of a corresponding flange and has a wire placement surface on which the wire is disposed,
a plated metal film is on the wire placement surface,
in connection portions between the wire and the wire placement surface, the wire extends along the wire placement surface and is bonded to the wire placement surface by a bonding member that includes a metal derived from the plated metal film, and
at an end of the wire placement surface from which the wire extends toward the winding core portion, a fillet including the metal derived from the plated metal film fills in a gap between the wire and the wire placement surface at at least one of the connection portions between the wire and the wire placement surface.

2. The coil component according to claim 1, wherein
the wire includes a compressed portion and a noncompressed portion configured from a tip end of the wire to the winding core portion in this order, along a portion of the wire that extends along the wire placement surface,
the compressed portion is closer to the tip end of the wire and has a flattened shape due to thermocompression bonding,
the noncompressed portion is closer to the winding core portion and has a circular shape or a substantially circular shape in a cross-section of the wire,
the noncompressed portion includes a first noncompressed portion closer to the tip end of the wire and a second noncompressed portion closer to the winding core portion,
a portion of the wire that is wound around the winding core portion has a circular shape or a substantially circular shape in a cross-section of the wire,
the wire includes an insulating film,
in the compressed portion, the insulating film is present intermittently and is not present at least on a surface portion of the wire that faces the wire placement surface,
in the first noncompressed portion, the insulating film is present continuously in a longitudinal direction of the wire except where at a location of the fillet, and
in the second noncompressed portion, the insulating film is present continuously in the longitudinal direction of the wire and also around an entire circumference of the wire.

3. The coil component according to claim 1, wherein
the fillet includes an alloy made of a metal included in the plated metal film and a metal included in the wire.

4. The coil component according to claim 3, wherein
the wire includes copper,
the plated metal film includes a nickel layer as a base and a tin layer as a surface layer, and
the alloy includes Sn—Cu alloy or Sn—Cu—Ni alloy.

5. The coil component according to claim 1, wherein
the wire placement surface includes a reference surface, a first slope, and a second slope in an order from a tip end of the wire toward the winding core portion,
the reference surface extends parallel to, or substantially parallel to, the axial direction of the winding core portion,
the first slope inclines such that the first slope comes closer to the top surface of the corresponding flange as the first slope comes further away from the reference surface,
the second slope further inclines relative to the first slope such that the second slope comes closer to the top surface of the flange as the second slope comes further away from the first slope, and
the fillet fills in the gap between the wire and at least the second slope.

6. The coil component according to claim 5, wherein
the wire includes a compressed portion and a noncompressed portion configured from a tip end of the wire to the winding core portion in this order, along a portion of the wire that extends along the wire placement surface,
the compressed portion is closer to the tip end of the wire and has a flattened shape due to thermocompression bonding,
the noncompressed portion is closer to the winding core portion and has a circular shape or a substantially circular shape in a cross-section of the wire,
the noncompressed portion includes a first noncompressed portion closer to the tip end of the wire and a second noncompressed portion closer to the winding core portion,
a portion of the wire that is wound around the winding core portion has a circular shape or a substantially circular shape in a cross-section of the wire,
the wire includes an insulating film,
in the compressed portion, the insulating film is present intermittently and is not present at least on a surface portion of the wire that faces the wire placement surface,
in the first noncompressed portion, the insulating film is present continuously in a longitudinal direction of the wire except at a location of the fillet, and
in the second noncompressed portion, the insulating film is present continuously in the longitudinal direction of the wire and also around an entire circumference of the wire.

7. The coil component according to claim 6, wherein
in the longitudinal direction of the wire on the wire placement surface, a projected region of the second slope is closer to the compressed portion than is a projected boundary between the first noncompressed portion and the second noncompressed portion.

8. The coil component according to claim 6, wherein
in the longitudinal direction of the wire on the wire placement surface, a projected region of the second slope is included in a projected region of the first noncompressed portion.

9. The coil component according to claim 8, wherein
in the longitudinal direction of the wire on the wire placement surface, the projected region of the second slope is closer to the compressed portion than is a projected boundary between the first noncompressed portion and the second noncompressed portion.

10. The coil component according to claim 1, wherein
a surface of the fillet that is exposed outside has a concave shape when a cross section of the fillet is viewed along a plane that extends in a longitudinal direction of the wire and in a direction orthogonal to the wire placement surface.

11. The coil component according to claim 2, wherein
a surface of the fillet that is exposed outside has a concave shape when a cross section of the fillet is viewed along a plane that extends in the longitudinal direction of the wire and in a direction orthogonal to the wire placement surface.

12. The coil component according to claim 3, wherein
a surface of the fillet that is exposed outside has a concave shape when a cross section of the fillet is viewed along a plane that extends in a longitudinal direction of the wire and in a direction orthogonal to the wire placement surface.

13. The coil component according to claim 4, wherein
a surface of the fillet that is exposed outside has a concave shape when a cross section of the fillet is viewed along a plane that extends in a longitudinal direction of the wire and in a direction orthogonal to the wire placement surface.

14. The coil component according to claim 5, wherein
a surface of the fillet that is exposed outside has a concave shape when a cross section of the fillet is viewed along a plane that extends in a longitudinal direction of the wire and in a direction orthogonal to the wire placement surface.

15. The coil component according to claim 6, wherein
a surface of the fillet that is exposed outside has a concave shape when a cross section of the fillet is viewed along a plane that extends in the longitudinal direction of the wire and in a direction orthogonal to the wire placement surface.

16. The coil component according to claim 7, wherein
a surface of the fillet that is exposed outside has a concave shape when a cross section of the fillet is viewed along a plane that extends in the longitudinal direction of the wire and in a direction orthogonal to the wire placement surface.

17. The coil component according to claim 8, wherein
a surface of the fillet that is exposed outside has a concave shape when a cross section of the fillet is viewed along a plane that extends in the longitudinal direction of the wire and in a direction orthogonal to the wire placement surface.

18. The coil component according to claim 9, wherein
a surface of the fillet that is exposed outside has a concave shape when a cross section of the fillet is viewed along a plane that extends in the longitudinal direction of the wire and in a direction orthogonal to the wire placement surface.
